(19) United States
(12) Patent Application Publication
(10) Pub. No.: US 2007/0040930 A1
(43) Pub. Date: Feb. 22, 2007

(54) Security camera

(75) Inventor: Woon-ho Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/367,408

(22) Filed: Mar. 6, 2006

(30) Foreign Application Priority Data
Aug. 19, 2005 (KR) 2005-0076496

(51) Int. Cl. B05B 1/00; H04N 5/225

(52) U.S. Cl. 348/373; 239/602

(57) ABSTRACT

The security camera includes a case body, and a fixed circuit board disposed in the case body. A middle plate is disposed above the fixed circuit board at a prescribed interval. A camera unit is horizontally and vertically rotatably disposed above the middle plate. A coupling unit enables the fixed circuit board to be assembled and disassembled outside of the case body. The coupling unit includes a screw-coupling boss having one end supported on one surface of the middle plate and the other end exposed outside of the case body. A coupling screw is coupled to the screw-coupling boss exposed to a lower surface of the case body.

### CROSS-REFERENCE TO RELATED APPLICATIONS

This application claims the benefit under 35 U.S.C. § 119(a) of Korean Patent Application No. 2005-76496 filed on Aug. 19, 2005, the entire contents of which are hereby incorporated by reference.

### BACKGROUND OF THE INVENTION

Field of the Invention

The present invention relates to a security camera. More particularly, the present invention relates to a security camera in which a power circuit board formed as the fixed circuit board is easily disassembled.

2. Description of the Prior Art

Generally, a security camera is installed and used in specific places, such as houses, parking places, department stores, banks and exhibition halls, for preventing an illegal act or a robbery from occurring.

The security camera described above may be classified as a fixed type camera capable of watching or observing a limited area or a moveable type camera employing a pan tilt motor and capable of watching or observing a wide area.

However, a change in the angle of the fixed type camera cannot be achieved. Thus, a plurality of cameras should be provided in several places for watching multiple areas in one space. To reduce the number of required cameras there has been a trend away from the fixed type camera toward the movable type camera.

An example of the movable type camera is disclosed in Japanese patent laid-open publication No. 2001-174902. According to the camera in Japanese patent laid-open publication No. 2001-174902, various types of electrical components installed in a rotatable case are coupled with a circuit board provided in a base installed at a ceiling and the like through coupling cables.

Generally, a power circuit board that supplies necessary power to each operating section of the camera unit, such as a camera lens module, a horizontally rotatable unit and a vertically rotatable unit or receives signals on the image information transmitted from the above camera lens module, is provided in the base as described above.

FIG. 1 is a view showing a structure of a security camera according to the prior art. Referring to FIG. 1, the security camera includes a case body 1, a camera unit 10 and a power unit 30.

The camera unit 10 comprises a first housing 13 in which a camera lens module 11 is received. Left and right brackets 15a and 15b rotatably support the first housing 13. A vertically rotatable unit 16 vertically rotates the first housing 13. A second housing 17 covers the left and right brackets 15a and 15b and the first housing 13. The camera unit includes a horizontally rotatable plate 19 on which the first housing 13, the left and right brackets 15a and 15b and the second housing 17 are mounted. A horizontally rotatable unit 21 horizontally rotates the rotational plate 19. A movable circuit board 23 is installed at one side of the rotational plate 19.

The power unit 30 includes a fixed circuit board 31 for supplying the power required for operating the camera unit 10 or for interfacing the signal transmitted from the camera unit 10. The fixed circuit board 31 is coupled with a fixed plate 33 and received in the case body 1 together with the fixed plate 33. In FIG. 1, reference numeral 35 indicates a rotational support member that rotatably supports the rotational plate 19 and for preventing a coupling cable (not shown) from being twisted.

The conventional security camera as described above has problems that the fixed circuit board 31 is coupled to the fixed plate 33 such that the each must be separated for individual inspection. A coupling screw 37 disposed at an upper side of the fixed circuit board 31 to couple the fixed circuit board 31 with the fixed plate 33. Thus, all components mounted on the fixed circuit board 31 must be separated from the fixed circuit board 31 after the case body 1 is separated if there is a need to inspect or repair the fixed circuit board 31.

Accordingly, a need exists for a security camera that has an easily disassembled power circuit board.

### SUMMARY OF THE INVENTION

Accordingly, an aspect of an exemplary embodiment of the present invention is to provide a security camera in which a power circuit board formed as the fixed circuit board may be easily disassembled.

A security camera according to an exemplary embodiment of the present invention includes a case body, and a fixed circuit board disposed in the case body. A middle plate is disposed above the fixed circuit board at a predetermined interval. A camera unit is horizontally and vertically rotatably installed above the middle plate. A coupling unit enables the fixed circuit board to be assembled and disassembled outside of the case body.

According to an exemplary implementation of the present invention, the coupling unit includes a screw-coupling boss having one end supported on a surface of the middle plate and the other end exposed outside of the case body. A coupling screw is coupled to the screw-coupling boss exposed to a lower surface of the case body.

According to an exemplary implementation of the present invention, the fixed circuit board has a penetrating hole formed thereon. The screw-coupling boss passes through the penetrating hole of the fixed circuit board.

According to an exemplary implementation of the present invention, the case body has a bottom plate installed therein. The bottom plate has a heat radiating pan for compulsorily radiating heat generated on the fixed circuit board.

According to an exemplary implementation of the present invention, the bottom plate has a coupling hole formed thereon. The coupling screw coupled to the screw-coupling boss passes through the coupling hole.

The bottom plate may be coupled to the case body.

The fixed circuit board may be fixed to a lower surface of the middle plate by the coupling screw.

The security camera may include an insulator disposed between the middle plate and the fixed circuit board.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a perspective view of a conventional security camera;

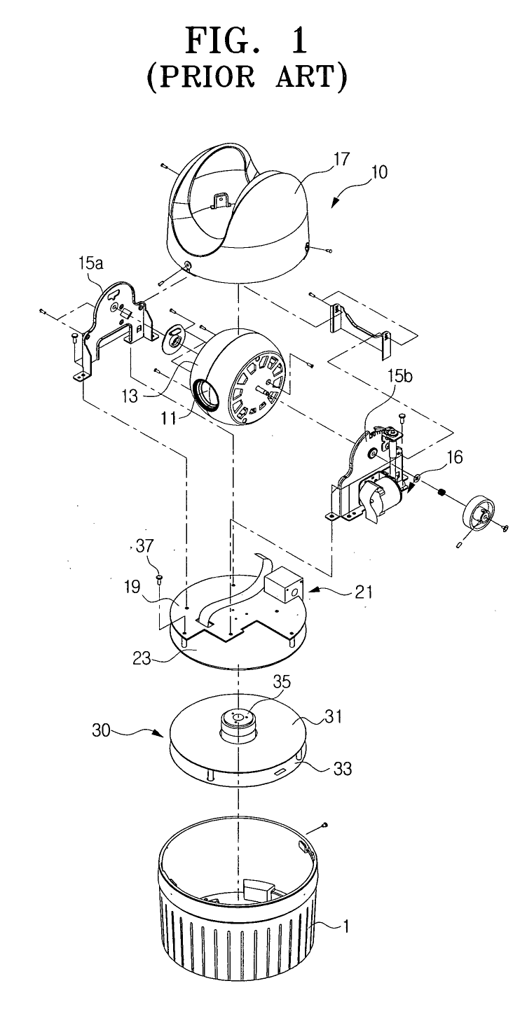

FIG. 2 is a perspective view of a security camera according to an exemplary embodiment of the present invention;

FIG. 3 is an exploded perspective view of the security camera of FIG. 2;

FIG. 4 is an enlarged exploded perspective view of section IV of FIG. 3;

FIG. 5 is an enlarged exploded perspective view of section V of FIG. 3;

FIG. 6 is a elevational view in cross section of a coupling unit of an exemplary embodiment of the present invention; and

FIG. 7 is an exploded perspective view of the assembled power section according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

Hereinafter, a security camera according to an exemplary embodiment of the present invention is described in detail with reference to the accompanying drawing figures.

The matters defined in the description, such as a detailed construction and elements thereof, are provided to assist in a comprehensive understanding of the invention. Thus, it is apparent that the present invention may be carried out without those defined matters. Also, well-known functions or constructions are omitted to provide a clear and concise description.

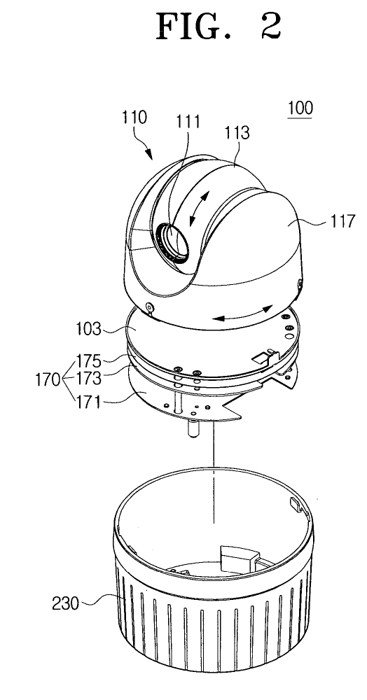

FIG. 2 is a perspective view of a security camera according to an exemplary embodiment of the present invention. Referring to FIG. 2, a security camera 100 according to an exemplary embodiment of the present invention includes a camera unit 110, a power unit 170 and a case body 230.

The camera unit 100 includes a camera lens module 111, and a first housing 113 vertically rotatably supporting the camera lens module 111. A second housing 117 receives the first housing 113 in which the camera lens module 111 is received. The second housing 117 is horizontally rotatably supported.

The power unit 170 supplies the power required for operating the camera and includes a bottom plate 171 and a power circuit board 173 that is a fixed circuit board installed above the bottom plate 171. An insulator 175 is installed above the power circuit board 173 and a middle plate 103 is installed above the insulator 175.

The power unit 170 is fixed to a bottom of an inside of the case body 230. The camera unit 110 is rotatably supported on the middle plate 103. The case body 230 is fixed to a ceiling, a wall, or any suitable support.

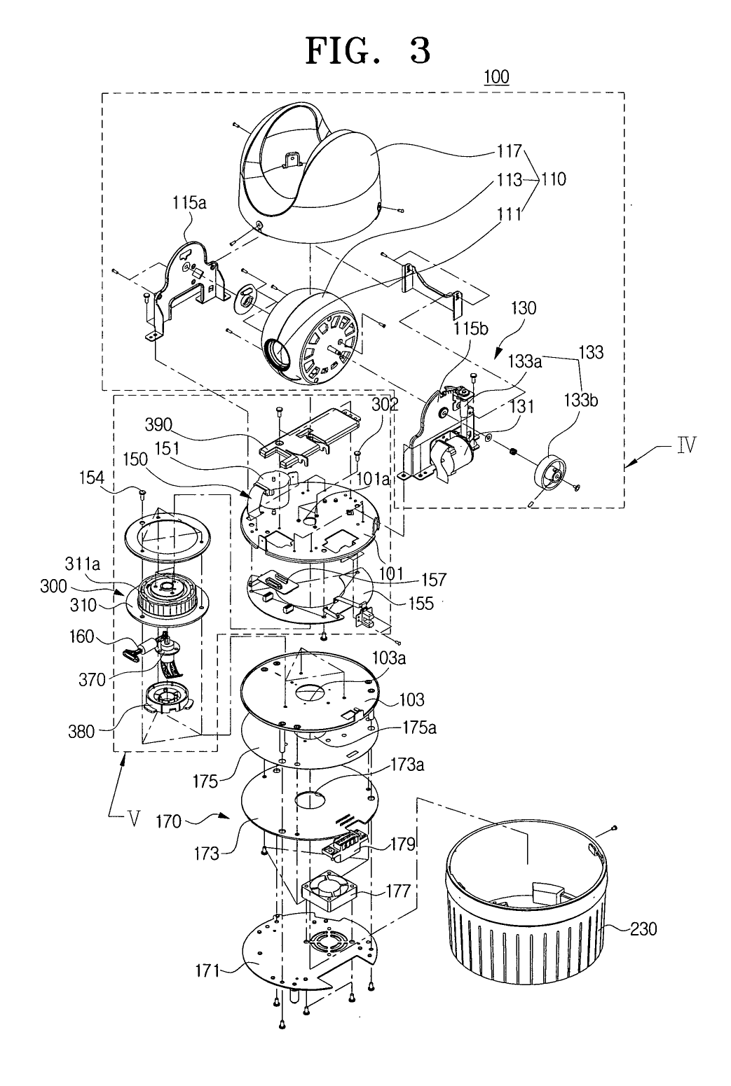

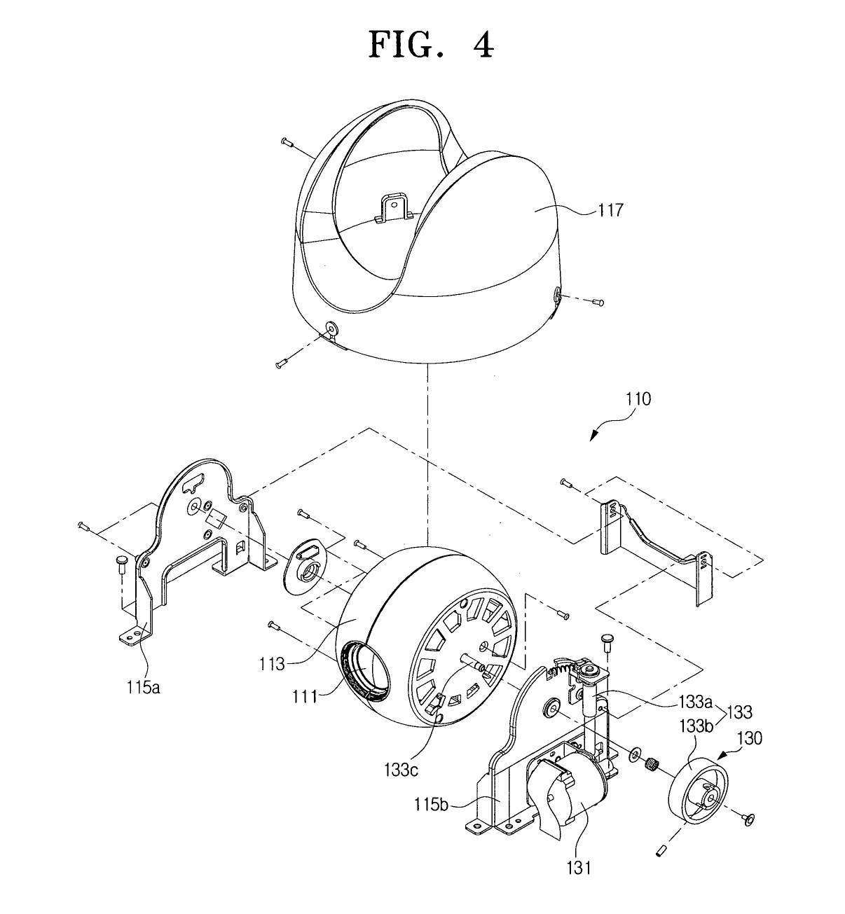

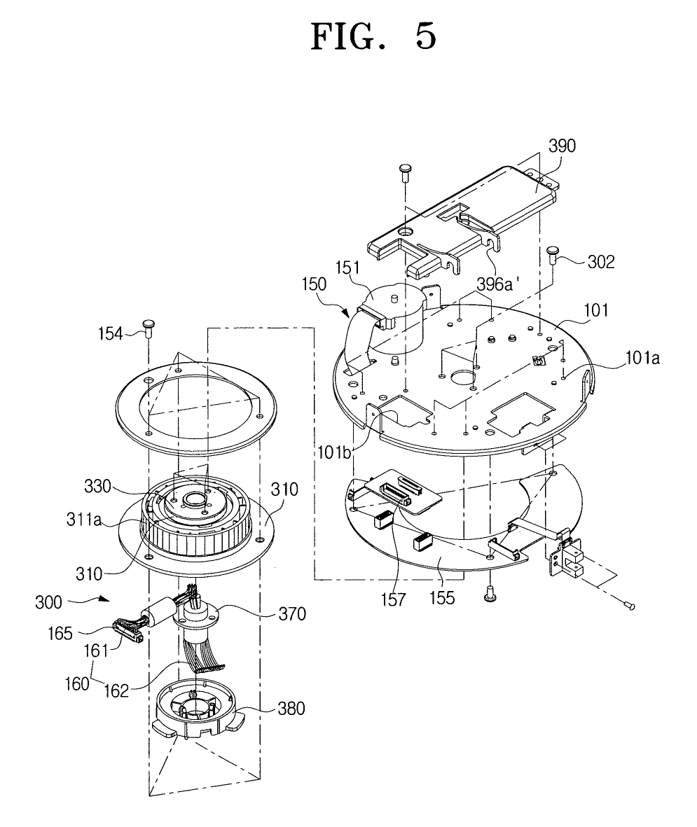

FIG. 3 is an exploded perspective view of the security camera according to an exemplary embodiment of the present invention shown in FIG. 2. FIG. 4 is an enlarged exploded perspective view of section IV of FIG. 3. FIG. 5 is an enlarged, exploded perspective view of section V of FIG. 3.

Referring to FIG. 3, the security camera 100 includes the camera unit 110, a vertically rotatable unit 130, a horizontally rotatable unit 150, the power unit 170, a slip ring 370, a coupling unit 300 and the case body 230.

Referring to FIG. 3 and FIG. 4, the camera unit 110 is vertically and horizontally rotatably installed at an upper surface of a top plate 101. The camera unit 110 includes the first housing 113 in which the camera lens module 111 is received. A pair of camera brackets 115a and 115b support the first housing 113 on an upper surface of the top plate 101. The second housing 117 receives the first housing 113 supported by the camera brackets 115a and 115b.

The vertically rotatable unit 130 includes a first rotational motor 131 mounted to one of the camera brackets 115a and 115b and a gear unit 133 (including shaft 133a bearing 133b and pin 133c) rotated according to the first rotational motor 131. The first housing 113 includes the camera lens module 111, which is vertically rotated by the gear unit 133.

Referring to FIG. 3 and FIG. 5, the horizontally rotatable unit 150 includes a second rotational motor 151 mounted to an upper surface of the top plate 101. A gear unit (not shown) includes a gear pan 310 coupled with the second rotational motor 151 for rotating the top plate 101. A motor circuit board 155 is a movable circuit board disposed on a lower surface of the top plate 101. The motor circuit board 155 has a connector socket 157 disposed thereon. A coupling cable connector 165 is disposed at one end of an upper coupling cable 161 to be coupled with the connector socket 157.

The gear pan 310 is fixed to an upper surface of the middle plate 103 by a coupling screw 154 and has gear teeth 311a formed on an outer circumference surface thereof. Accordingly, once a pinion gear (not shown) coupled with a motor shaft of the second rotational motor 151 is horizontally rotated along the gear teeth 311a, the top plate 101 is horizontally rotated, and so the camera unit 110 is horizontally rotated. When operating, the rotational motor 151 is revolved together with the top plate 101.

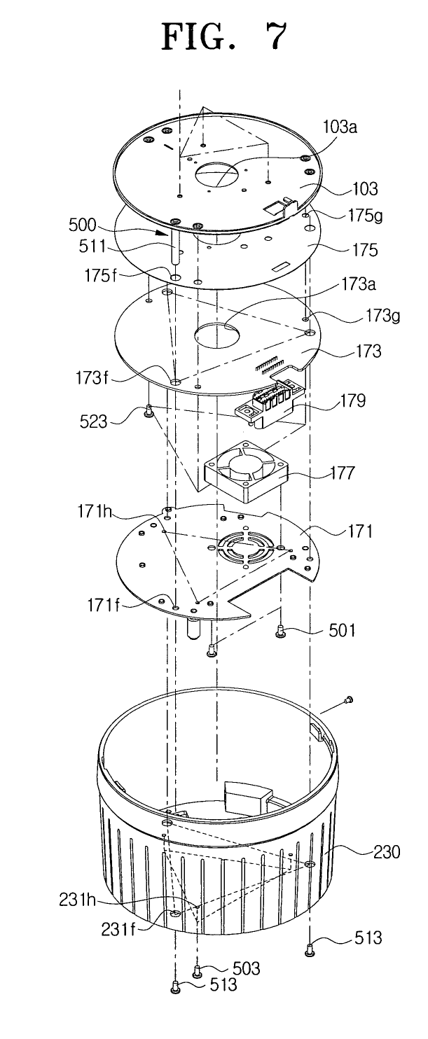

Referring to FIG. 3, the power unit 170 supplies power to the camera unit 110, the vertically rotatable unit 130, the horizontally rotatable unit 150 and other components of the camera 100. The power unit 170 includes the bottom plate 171 and the power circuit board 173, which is a fixed circuit board installed above the bottom plate 171. A power socket 179 coupled with an exterior power socket (not shown) is provided on the power circuit board 173. A heat radiating pan 177 is installed on the bottom plate 171 for radiating heat generated when the power circuit board 173 is operated. The insulator 175 is bonded to a lower surface of the middle plate 103 for insulating between the middle plate 103 and the power circuit board 173. The coupling structure of the power unit 170 is described in more detail with reference to FIG. 7 below.

The bottom plate 171 is installed on a bottom of an inside of the case body 230.

A structure for coupling the coupling cable 160 with the motor circuit board 155, which is rotating, and the power circuit board 173, which is fixed in the case body 230 in a stationary state, without twisting of the coupling cable and for rotatably supporting the top plate is described in more detail.

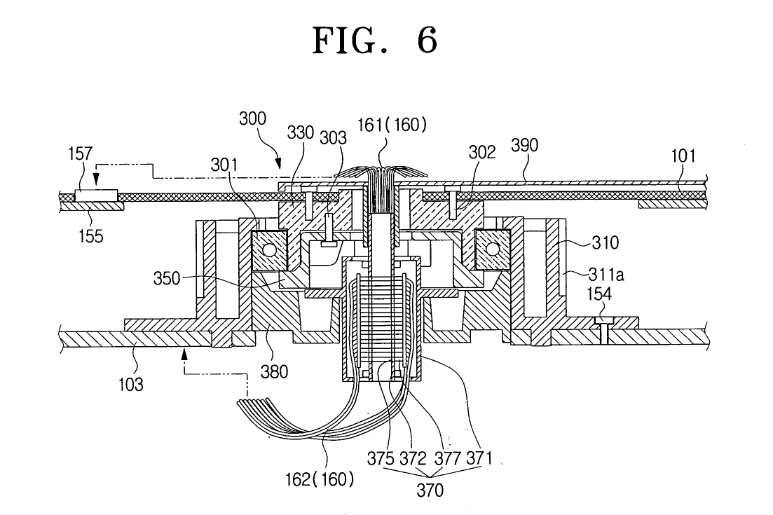

FIG. 6 is an elevational view in cross section of the coupling unit according to an exemplary embodiment of the present invention.

Referring to FIG. 5 and FIG. 6, the coupling unit 300 includes a bearing 301 inserted in the gear pan 310. A bearing holder 330 is received in an upper side of the bearing 301 and is coupled to the top plate 101 by coupling screws 302. A cover bearing 350 is received in a lower side of the bearing 301 and is coupled to the bearing holder 330 by coupling screws 303. The slip ring 370 is disposed in the cover bearing 350 and has both ends through which the upper coupling cable 161 and a lower coupling cable 162, which constitute the coupling cable 160, are drawn. A slip ring holder 380 fixes the slip ring 370 in the gear pan 310. The bearing holder 330 is coupled to the top plate 101 by the coupling screw 302.

The slip ring 370 couples the coupling cable 160 to the motor circuit board 155, which rotates, and to the fixed power circuit board 173 such that the coupling cable is not twisted. A slip ring main body 371 has a rotational shaft 372 provided therein. The rotational shaft 372 has a hollow cylindrical shape and a plurality of slider contact terminals 375 disposed on the rotational shaft 372. Accordingly, one end of the upper coupling cable 161 is contacted with the slider contact terminal 375 in the rotational shaft 372. A fixed contact terminal 377 contacts the slider contact terminals 375 disposed at an outer side of the rotational shaft 372 and the lower coupling cable 162 is coupled to the fixed contact terminal 377. When the top plate 101 is rotated, the rotational shaft 372 is rotated and the slider contact terminals 375 coupled to the rotational shaft 372 and the upper coupling cable 161 are simultaneously rotated. The fixed contact terminal 377 and the lower coupling cable 162, including the slip ring main body 371, are maintained in the stationary state. The coupling cable connector 165 coupled to the connector socket 157 disposed on the motor circuit board 155 is coupled with one end of the upper coupling cable 161.

In FIG. 3 and FIG. 6, reference numeral 390 indicates a wire guide provided for substantially preventing movement of the upper coupling cable 161 drawn above the top plate 101.

The power section according to an exemplary embodiment of the present invention is described in more detail below.

FIG. 7 is an enlarged exploded perspective view of the power section according to an exemplary embodiment of the present invention.

In the power unit, referring to FIG. 7, the bottom plate 171 is coupled to a bottom of an inside of the case body 230. The power circuit board 173, the insulator 175 and the middle plate 103 are sequentially coupled to an upper side of the bottom plate 171. The power circuit board 173 may be easily assembled and disassembled outside of the case body 230 by a coupling unit 500.

The coupling unit 500 has one end supported at one surface of the middle plate 103. The other end of the coupling unit 500 includes a screw-coupling boss 511 exposed outside of the case body 230 and a coupling screw 513 coupled to the screw-coupling boss 511 exposed to a lower surface of the case body 230. A coupling hole 231f is formed in the case body 230 through which the coupling screw 513 passes. A penetrating hole 173f is formed in the power circuit board 173 through which the screw-coupling boss 511 passes.

The power circuit board 173 is mounted integrally to a lower surface of the middle plate 103 by a coupling screw 523. A coupling hole 173g is formed in the power circuit board 173 through which the coupling screw 523 passes.

The insulator 175 is bonded to a lower surface of the middle plate 103 by an adhesive, such as double-sided adhesive tape. The fixed circuit board 173 is insulated from the middle plate 103 by the insulator 175. Preferably, a penetrating hole 175f is formed in the insulator 175 through which the screw-coupling boss 511 passes and a penetrating hole 175g is formed in the insulator 175 through which the coupling screw 523 passes.

The bottom plate 171 is installed on a bottom in the case body 230. The heat radiating pan 177 is installed on the bottom plate 171 for radiating heat generated at the power circuit board 173. The heat radiating pan 177 is coupled to the bottom plate 171 by the coupling screw 501. The penetrating hole 175f corresponding to the screw-coupling boss 511 is formed on the bottom plate 171. The bottom plate 171 is coupled to the case body 230 by the coupling screw 503. A coupling hole 171h is formed in the bottom plate 171 with which the coupling screw 503 is coupled. A coupling hole 231h is formed in the case body 230 with which the coupling screw 503 is coupled.

Reference numeral 179 in the drawing indicates the power socket coupled with an exterior power electric socket (not shown).

A method for coupling the power circuit board 173 with the case body 230 outside of the case body and a process for disassembling the power circuit body and the case body is described below.

After the insulator 175 is bonded to a lower surface of the middle plate 103, the power circuit board 173 is coupled integrally with a lower side of the middle plate 103 by the coupling screw 523. The power socket 179 or the lower coupling cable 162 (see FIG. 3, FIG. 5 and FIG. 6) may be coupled with a lower side of the power circuit board 173.

The bottom plate 171 is placed on a bottom in the case body 230. The bottom plate 171 is then coupled with the case body 230 by the coupling screws 503.

Then, the heat radiating pan 177 is mounted to an upper surface of the bottom plate 171 by the coupling screw 501.

An assembly in which the middle plate 103, the insulator 175 and the power circuit board 173 are coupled together is placed in the case body 230. The above members are aligned such that the screw-coupling boss 511 corresponds to the penetrating hole 171f of the bottom plate 171 and the penetrating hole 231f of the case body 230. The coupling screw 513 is then inserted in and coupled with the screw-coupling boss 511 outside of the case body 230, thereby completing the assembling process for the power unit.

When the power unit is disassembled for inspecting or repairing the power circuit board 173, once the coupling screw 513 is unscrewed, the middle plate 103, the camera unit 110 coupled to an upper side of the middle plate 103 and the power circuit board 173 coupled to a lower side of the middle plate may be separated from the case body 230. When the coupling screw 503 is not unscrewed, the bottom plate 171 remains coupled with the case body 230.

According to the security camera according to an exemplary embodiment of the present invention as described above, when the power circuit board is disassembled for inspecting or repairing, the power circuit board may be easily disassembled by unscrewing only the coupling screws without disassembling a large number of the components.

Accordingly, an exemplary embodiment of the present invention is advantageous in that the productivity and the efficiency of inspection or reparation are enhanced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus, comprising:
a case body;
a fixed circuit board disposed in the case body;
a middle plate disposed above the fixed circuit board;
a camera unit horizontally and vertically rotatably disposed above the middle plate; and
a coupling unit enabling the fixed circuit board to be assembled and disassembled outside of the case body.

2. The apparatus according to claim 1, wherein the coupling unit includes
a screw-coupling boss having one end supported on a surface of the middle plate and the other end exposed outside of the case body; and
a coupling screw coupled with the screw-coupling boss exposed to a lower surface of the case body.

3. The apparatus according to claim 2, wherein
the fixed circuit board has a penetrating hole through which the screw-coupling boss passes.

4. The apparatus according to claim 2, wherein
the case body has a bottom plate.

5. The apparatus according to claim 4, wherein
the bottom plate has a heat radiating pan for radiating heat generated on the fixed circuit board.

6. The apparatus according to claim 4, wherein
the bottom plate has a coupling hole for passing the coupling screw coupled with the screw-coupling boss.

7. The apparatus according to claim 4, wherein
the bottom plate is coupled with the case body.

8. The apparatus according to claim 2, wherein
the fixed circuit board is fixed to a lower surface of the middle plate by the coupling screw.

9. The apparatus according to claim 1, wherein
an insulator is disposed between the middle plate and the fixed circuit board.

10. The apparatus according to claim 9, wherein
the insulator is bonded to a lower surface of the middle plate by an adhesive.

11. The apparatus according to claim 1, wherein
the middle plate is spaced from the fixed circuit board.

12. An apparatus, comprising:
a case body;
a fixed circuit board disposed in the case body;
a middle plate disposed above and spaced from the fixed circuit board;
an insulator disposed between the middle plate and the fixed circuit board;
a camera unit horizontally and vertically rotatably disposed above the middle plate; and
a coupling unit enabling the fixed circuit board to be assembled and disassembled outside of the case body.

13. The apparatus according to claim 12, wherein the coupling unit includes
a screw-coupling boss having one end supported on a surface of the middle plate and the other end exposed outside of the case body; and
a coupling screw coupled with the end of the screw-coupling boss exposed to a lower surface of the case body.

14. The apparatus according to claim 13, wherein
the fixed circuit board has a penetrating hole for passing the screw-coupling boss therethrough.

15. The apparatus according to claim 12, wherein
the bottom plate has a heat radiating pan for radiating heat generated on the fixed circuit board.

16. The apparatus according to claim 15, wherein
the bottom plate has a coupling hole for passing the coupling screw to couple with the screw-coupling boss.

17. The apparatus according to claim 13, wherein
the fixed circuit board is fixed to a lower surface of the middle plate by the coupling screw.

18. The apparatus according to claim 12, wherein
the insulator is bonded to a lower surface of the middle plate by an adhesive.
